(19) United States
(12) Patent Application Publication
(10) Pub. No.: US 2003/0000727 A1
(43) Pub. Date: Jan. 2, 2003

(54) Spiral sprung cable

(75) Inventors: Klaus Nothofer, Erkrath (DE); Hans-Detlef Leppert, Monchengladbach (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/179,297

(22) Filed: Jun. 26, 2002

(30) Foreign Application Priority Data
Jun. 27, 2001 (EP) 01 440 194.7

(51) Int. Cl. H01B 7/00

(52) U.S. Cl. 174/110 R

(57) ABSTRACT

For the purpose of laying telecommunications cable in a pipe a cable or length of cable has been developed which is formed from a spiral spring which has a diameter equal to or larger than the diameter of the pipe and a stiffness and possibly a spring force sufficiently strong for it to be pressed against the inner wall of the pipe in the installed state and thus maintaining a lasting laid state.

### BACKGROUND OF THE INVENTION

The invention is based on a priority application EP01440194.7 which is hereby incorporated by reference.

The invention relates to a cable or length of cable for laying in a pipe, preferably a non-accessible waste water pipe, and a method for laying such cables or length of cables.

Using waste water, rainwater or mixed water channels or other end or supply conduits for laying communication cables is a possibility already being exploited to lower the costs of underground work for subscriber access. It also enables subscriber access of this kind to be extended orientated to need and quickly, which is becoming increasingly important of late owing to the multiplicity of operators. Hereinafter the term waste water channel (waste water pipe) will also comprise rainwater channels, mixed water channels and end and supply conduits. Standard techniques for laying communication cables are employed with accessible channels. If the channels have an insufficiently large minimum diameter for crawling along without danger, alternative solutions have to be found. Robots are increasingly being used in inaccessible channels, to enable cables to be laid there. But even robots need a minimum diameter, which cannot always be guaranteed. These problems are typical of the so-called last mile, i.e. the lateral stretch of the channel up to the direct access to a building. The diameter can therein be smaller than 20 cm. Today they are still, for the most part, unsatisfactorily solved.

In the laying of cables in non-accessible waste water channels the following should be ensured:

the hydraulically useable cross-sectional face is only minimally reduced,

if possible no objects should be placed diagonally to the direction of flow,

no contact points arise which may lead to the formation of snags (e.g. accumulation of sewage materials) and as a result to blockage, and also not too much hindrance is caused in the cleaning of the waste water channel.

### SUMMARY OF THE INVENTION

The object of the invention is to further develop cables or length of cables which can easily be inserted into non-accessible channels and maintain a lasting laid state.

The object is achieved according to the invention by

a cable or length of cable for laying in a pipe, wherein the said cable or length of cable is formed from a spiral spring which has a diameter equal to or larger than the diameter of the pipe and a stiffness and possibly a spring force sufficiently strong for it to be pressed against the inner wall of the pipe in the installed state; and

a method for laying a cable or length of cable in a pipe, wherein said cable or length of cable is formed from a spiral spring which has a diameter equal to or larger than the diameter of the pipe and a stiffness and possibly a spring force sufficiently strong for it to be pressed against the inner wall of the pipe in the installed state and the spring is held taut during laying at a diameter smaller than the diameter of the inner wall of the pipe, wherein in the laid state it is released; and

a method for manufacturing a cable or length of cable for laying in a pipe, wherein it is formed into a spiral spring.

The deformation of the cable or length of cable into a spiral spring enables forces to be exploited to press this cable or length of cable against the inner wall of the pipe into which the cable or length of cable is to be laid. This deformation is also relatively easy to carry out, wherein it should be ensured that the diameter of the spiral spring is chosen as equal to or larger than the diameter of the pipe. Additionally, the cable or the length of cable can be formed in such a way that it has a flat cross-section, in order to be able to rest with this cross-section as flat as possible against the inner wall of the pipe.

Advantageously the cable can be made of a pipe housing, preferably of steel, which can thus easily be deformed into a spiral spring and allows the possibility of inserting telecommunication cables, such as, e.g. optical waveguides, in this pipe housing.

Advantageous configurations of the invention emerge from the dependent claims, the following description and the drawings.

### BRIEF DESCRIPTION OF THE DRAWINGS

An embodiment example of the invention is now explained with the aid of FIGS. 1 to 4.

FIG. 1 shows a pipe, e.g. waste water pipe.

FIG. 2 shows a device for shaping a cable or length of cable according to the invention and a detailed view of the cross-section of the latter.

FIG. 3 shows a sketch of the laying of a cable or length of cable according to FIG. 2 in a pipe according to FIG. 1.

FIG. 4 shows a pipe according to FIG. 1 with the laid cable or length of cable according to the invention according to FIG. 2.

### DETAILED DESCRIPTION OF THE DRAWINGS

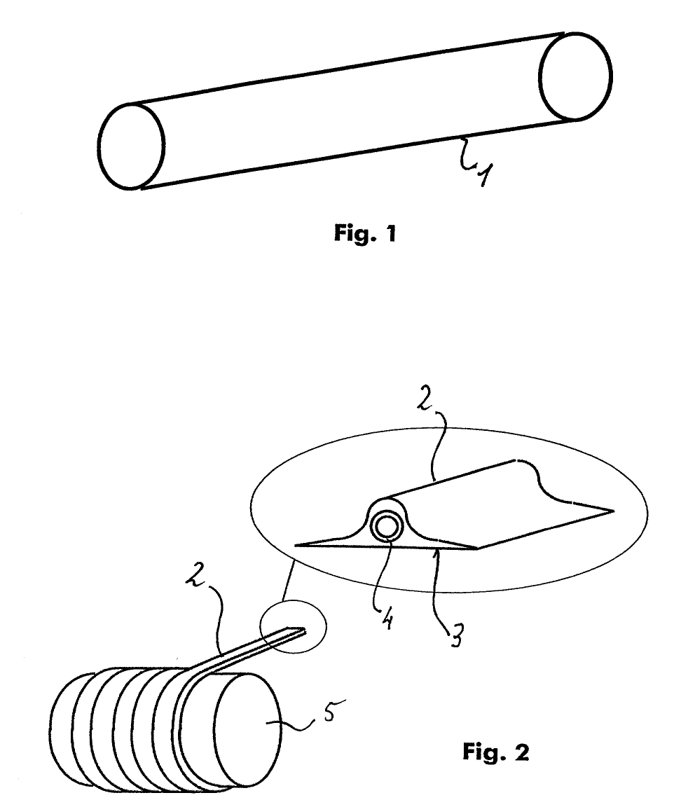

FIG. 1 shows a pipe 1, e.g. waste water pipe or waste water channel which has a certain cross-section. This pipe 1 can, e.g. be the lateral stretch which forms the last mile to the subscriber access.

FIG. 2 shows a cylinder 5 or pail pack, round which a cable or length of cable 2 according to the invention is wound. Additionally, the cross-section of this cable 2 is shown in a detailed view. The cable 2 therein has a flat side 3, which gives it a flattened cross-section, and surrounds a pipe housing 4. This pipe housing 4 is preferably made of steel. Thus, by shaping the cable or length of cable 2 into a spiral spring 6 a certain stiffness and possibly a spring force can be achieved. The shaping can be attained by winding the cable or length of cable 2 round the cylinder 5. For this the winding of the cable or length of cable 2 round the cylinder 5 may possibly have to be maintained for a certain time. The diameter of this cylinder 5 and the time for which the winding has to be maintained is directly dependent on the thickness of the materials chosen for the cable or length of cable 2, in particular of the pipe housing 4, and the diameter of the inner wall of the pipe 1 in which this cable or length of cable 2 is to be laid. It is therein important that the spring force gained by winding is sufficiently strong to press the cable or length of cable 2 lastingly against the inner wall of the pipe 1 in the laid state.

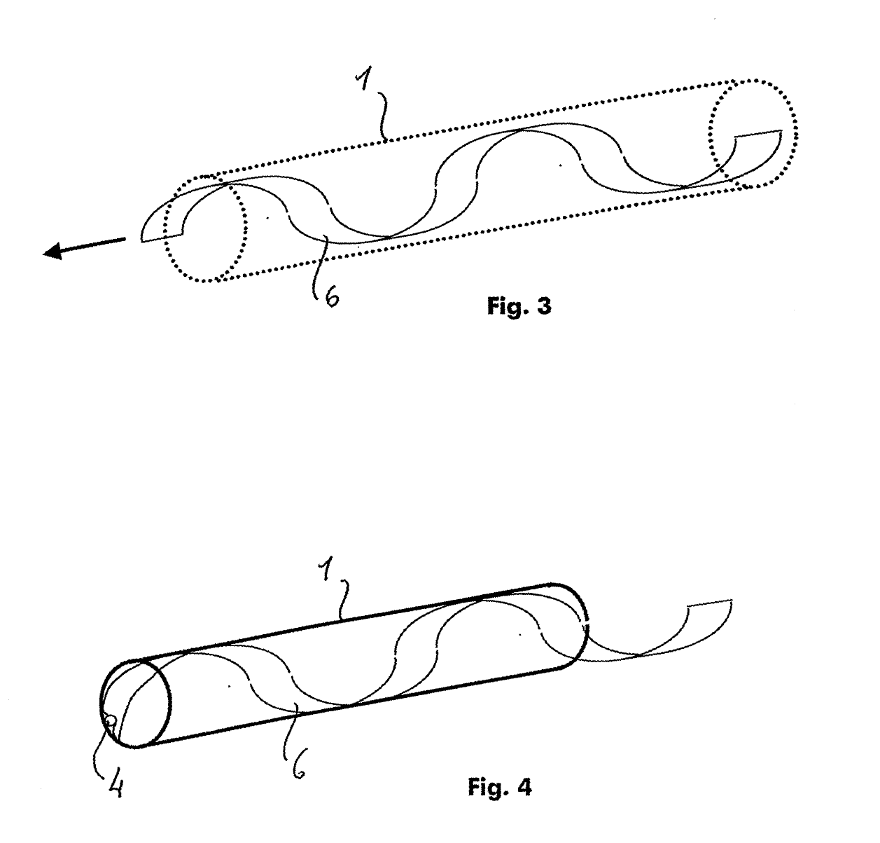

In FIG. 3 is schematically shown how a cable or length of cable 2 according to the invention in the form of a spring 6 is inserted into the inaccessible pipe. The spring is therein held taut at a diameter smaller than the diameter of the inner wall of the pipe 1 until laying is complete. It is then released, which results in the cable 6, formed as a spring, resting with the flat side 3 against the inner wall of the pipe 1. This final state is shown in FIG. 4. The pipe housing 4 can therein clearly be seen. In a pipe housing of this kind typically telecommunication cables such as optical waveguides can be inserted, which if necessary can be embedded in a filler substance such as gel.

Once the thread pitch of the spring 6 in the laid state in the pipe 1 is released, as shown in FIG. 4, it can advantageously correspond to 1 to 10 times the diameter of the pipe 1. This is directly dependent on the desired stiffness and possibly on the spring force of the attained spiral spring 6. Normal steel housings can be applied as pipe housing 4 with cables 2 of this kind, as used with optical ground wires.

1. Cable or length of cable for laying in a pipe, wherein the cable or length of cable is formed from a spiral spring which has a diameter equal to or larger than the diameter of the pipe and a stiffness and possibly a spring force sufficiently strong for it to be pressed against the inner wall of the pipe in the installed state.

2. Cable or length of cable according to claim 1, wherein it has a flat cross-section.

3. Cable or length of cable according to claim 1, wherein it has a pipe housing and telecommunication cables inserted in it.

4. Cable or length of cable according to claim 3, wherein optical waveguides with a filler substance are inserted in the pipe housing.

5. Method for laying a cable or length of cable in a pipe, wherein the cable or length of cable is formed from a spiral spring which has a diameter equal to or larger than the diameter of the pipe and a stiffness and possibly a spring force sufficiently strong for it to be pressed against the inner wall of the pipe in the installed state and the spring is held taut during laying at a diameter smaller than the diameter of the inner wall of the pipe, wherein in the laid state it is released.

6. Method of manufacturing a cable or length of cable for laying in a pipe, wherein it is formed into a spiral spring.

7. Manufacturing method according to claim 6, wherein the shaping into the spiral spring is attained in that the cable or length of cable is wound round a cylinder, wherein the latter has a diameter which is chosen accordingly to give the cable or length of cable sufficient stiffness and possibly spring force to guarantee that the cable or length of cable will rest against the inner wall of the pipe in the laid state.
